(19) United States
(12) Patent Application Publication
(10) Pub. No.: US 2009/0158787 A1
(43) Pub. Date: Jun. 25, 2009

(54) ANTI-THEFT DISPLAY CARD STRUCTURE

(76) Inventor: Tsung-Da LIN, Taiping City (TW)

Correspondence Address: Chien-Hui Su, P. O. Box 70-121 Taichung, Taichung City, 40899, TW

(21) Appl. No.: 11/963,847

(22) Filed: Dec. 23, 2007

(51) Int. Cl. E05B 73/00

(52) U.S. Cl. 70/58

(57) ABSTRACT

An anti-theft display card structure comprises a hanger portion, a connection portion and a stopper. The hanger portion has a fixing seat at an end thereof for the connection portion to clamp thereto and the fixing seat has a stop surface at each of two sides thereof The hanger portion has a clamping slot for receiving and securing the stopper. The clamping slot includes a receiving slot with a larger slot size, an engaging slot with a smaller slot size, and an arcuate seat formed between the receiving slot and the engaging slot. The arcuate seat is an engaging structure formed on two sides of the receiving slot, having arcuate surfaces, and tapering in one direction from the receiving slot towards the engaging slot, so that the stopper can only be pushed into the engaging slot from the receiving slot for being secured against theft.

### BACKGROUND OF THE INVENTION

1. Technical Field

The present invention relates to an anti-theft display card structure for being used with a sleeve. More particularly, the present invention relates to an anti-theft display card structure for being used with a sleeve wherein a hanger portion is provided with a stopper for preventing a rotating portion of the display card from rotating, so that the sleeve cannot separate from the rotating portion of the display card, thereby producing the effect of anti-theft and display.

2. Description of Related Art

Taiwan Patent Application No. 095220378 provides a hanging card for being used with sleeves that has anti-theft features. The hanging card comprises a frame having a fixed side panel and a movable side panel which correspond to each other and are provided on two sides of the frame, wherein a fastening element is provided between the movable side panel and the frame, and the fixed side panel of the frame includes a plurality of insert blocks formed on an inner surface thereof for inserting into and positioning the sleeves. The movable side panel is mounted to the frame at a lower edge thereof and includes a plurality of confining blocks on an inner surface thereof corresponding to the insert blocks on the fixed side panel for inserting into the sleeves from an opposite side thereof. The fastening element is an insert plate having a laid-down U shape and is provided on and protruding from the movable side panel. The laid-down U-shaped insert plate comprises a supporting section formed at a lower edge thereof and a fastening groove formed near an opening thereof The laid-down U-shaped insert plate further comprises a fastening block integrally formed on an inner top surface of the lower edge of the laid-down U-shaped insert plate. The fastening block can be pushed into the fastening groove and thereafter cannot be pulled out of the fastening grooved unless being cut off. In addition, the laid-down U-shaped insert plate further comprises a pressing portion formed on a top edge thereof that can move inwards. And a fastening edge is formed on a top surface of the laid-down U-shaped insert plate. The frame includes a fastening channel corresponding to the fastening element, which fastening channel has a pressing surface on an inner bottom surface thereof pressing against the supporting section on the lower edge of the laid-down U-shaped insert plate. The fastening channel further includes a stop tab extending therefrom for engaging with the fastening edge and the pressing portion of the laid-down U-shaped insert plate, thereby forming a hanging card structure that has anti-theft and storage features and provides adaptability for various sleeves.

While the above-mentioned hanging card for use with sleeves has storage, display and anti-theft features, its anti-theft feature is imperfect. For one, the anti-theft and storage features of all the sleeve receiving grooves in the frame are achieved through a single movable side panel. Moreover, the fasting block that serves to prevent theft is formed directly on the movable side panel, so that this hanger card structure provides unrepeatable anti-theft feature only for one time. If more anti-theft displays of the same hanger card structure are required, the entire movable side plate must be replaced to make the hanger card structure anti-theft for a second time.

### SUMMARY OF THE INVENTION

The anti-theft display card structure of the present invention not only has the anti-theft, display and storage features of a common hanging card, but also provides multiple anti-theft effects for more convenient use in display applications.

To achieve above object, the present invention provides an anti-theft display card structure, which has a body comprising a hanger portion, a connection portion and a stopper, wherein: the hanger portion includes a fixing seat for the connection portion to attach thereto and a clamping slot for receiving and securing the stopper, in which the stopper has a stop tab for limiting a rotational release of the connection portion in order to produce an anti-theft effect, and when the stop tab is removed, the connection portion can rotate so as to cancel the anti-theft effect. The stopper has an engaging end and the clamping slot includes a receiving slot with a larger slot size, an engaging slot with a smaller slot size, and an arcuate seat formed between the receiving slot and the engaging slot, in which the arcuate seat is an engaging structure with arcuate surfaces and tapering in one direction from the receiving slot towards the engaging slot, so that the engaging end of the stopper can be pushed from the receiving slot into the engaging slot and be secured by the arcuate seat, and the stop tab of the stopper can press against the fixing seat to limit rotation of the engaging end in the clamping slot.

Moreover, the present invention provides a n anti-theft display card structure, which has a body comprising an extended seat, a securing device, and one or a plurality of connection portions, wherein: the extended seat includes a fixing rod for the connection portion to attach rotationally thereto, in which the fixing rod has a retaining groove; the securing device includes a securing cap and an engaging strip for being inserted into the retaining groove and pressing against the connection portion, thereby limiting a rotational release of the connection portion to produce an anti-theft effect; the securing cap can confine the engaging strip inside the retaining groove; and when the securing cap is removed, the engaging strip is pulled out and the connection portion can rotate so as to canceled the anti-theft effect.

In addition to the above-mentioned anti-theft and display features, the present invention also provides a special renewable structure for multiple anti-theft effects, wherein, when a stop tab is cut off, a stopper is no longer confined by stop surfaces on both sides of a fixing seat and is allowed to rotate, so that an engaging end of the stopper can rotate in an engaging slot without being limited by an arcuate seat in terms of angle and position. At this time, removal of the stopper and replacement by a new stopper will have a new engaging end restrained by a new stop tab to provide multiple anti-theft effects. Compared with conventional structures which require replacement of an entire component, the present invention is more economical and convenient. Furthermore in the present invention, cooperation between the hanger portion and the stopper allows for single-sleeve anti-theft displays, thereby providing a variety of combination displays.

### BRIEF DESCRIPTION OF THE DRAWINGS

FIG. 1 is a schematic perspective exploded view of an anti-theft display card structure according to the present invention.

FIG. 2 is a schematic perspective view showing an appearance of the anti-theft display card structure according to the present invention.

FIG. 3 is a schematic perspective view showing another appearance of the anti-theft display card structure according to the present invention when a stopper is cut off.

FIG. 4 is a schematic cross-sectional view of the anti-theft display card structure according to the present invention.

FIG. 5 is a schematic cross-sectional view of the anti-theft display card structure according to the present invention showing separation of a sleeve.

FIG. 6 is a schematic perspective exploded view of a second embodiment of the anti-theft display card structure according to the present invention.

FIG. 7 is a schematic perspective view showing an appearance of the second embodiment of the anti-theft display card structure according to the present invention.

FIG. 8 is a schematic view of the second embodiment of the anti-theft display card structure according to the present invention showing the separation of a cap seat from a securing cap.

FIG. 9 is a schematic view of the second embodiment of the anti-theft display card structure according to the present invention showing engagement of the cap seat with the securing cap.

FIGS. 10 to 12 are schematic cross-sectional views showing operations for disabling the anti-theft function of the second embodiment of the anti-theft display card structure according to the present invention.

### DETAILED DESCRIPTION OF THE PREFERRED EMBODIMENT

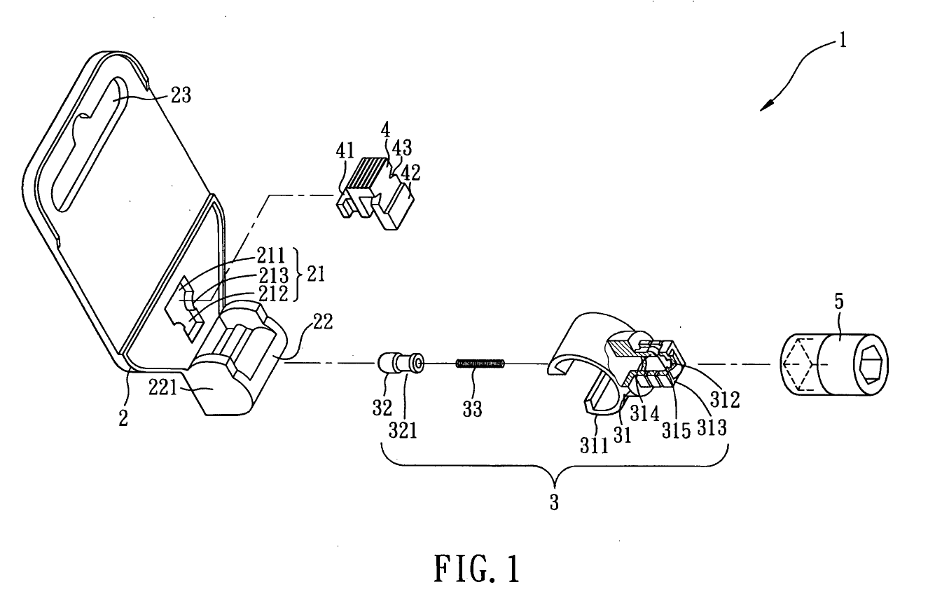

The present invention relates to an anti-theft display card structure as shown in FIG. 1. The anti-theft display card structure has a body 1 comprising a hanger portion 2, a connection portion 3 and a stopper 4.

The hanger portion 2 is formed with a fixing seat 22 at an end thereof and a hanging slot 23 at another end thereof for hanging the hanger portion 2. The fixing seat 22 allows the connection portion 3 to be attached rotationally thereto and includes a stop surface 221 on each of two sides thereof for confining the connection portion 3 on the fixing seat 22 and preventing the connection portion 3 from moving laterally. The hanger portion 2 includes a clamping slot 21 for receiving and securing the stopper 4. The clamping slot 21 has a receiving slot 211 with a larger slot size, an engaging slot 212 with a smaller slot size, and an arcuate seat 213 formed between the receiving slot 211 and the engaging slot 212. The arcuate seat 213 is an engaging structure with arcuate surfaces and tapers in one direction from the receiving slot 211 towards the engaging slot 212.

The connection portion 3 comprises a rotating portion 31, a pusher 32, and a resilient element 33. The rotating portion 31 includes an annular clamp 311, a hole 312, a sleeve retaining portion 313 and a pressing tab 314. The annular clamp 311 can be clamped to the fixing seat 22 so that the connection portion 3 can rotate on the fixing seat 22. The hole 312 has an opening formed on the annular clamp 311 and penetrates the sleeve retaining potion 313. The pressing tab 314 is located at an end of the sleeve retaining portion 313 of the rotating portion 31 and has a fixing block 315. The sleeve retaining portion 313 allows a sleeve 5 to be mounted thereon and can secure the sleeve 5 with the fixing block 315 pressing against the sleeve 5. The pusher 32 pushes against the fixing seat 22 at an end thereof and is received in the hole 312 together with the resilient element 33. The pusher 32 presses against the pressing tab 314 from inside, thereby limiting inward movement of the pressing tab 314 to provide a securing effect. The pusher 32 further includes a receding release portion 321. By moving the pusher 32 further into the hole 312, the release portion 321 is shifted to be in positional correspondence to the pressing tab 314, thereby removing the limitation on the inward movement of the pressing tab 314, so that the securing effect is canceled.

The stopper 4 has an engaging end 41 at an end thereof and a stop tab 42 extending from a lower edge at an opposite end thereof. The engaging end 41 can be placed into the clamping slot 21 for securing the stopper 4. Furthermore, as the arcuate seat 213 has arcuate surfaces and tapers in one direction, the engaging end 41 can be pushed from the receiving slot 211 into the engaging slot 212 and be secured by the arcuate seat 213. The stop tab 42 of the stopper 4 presses against the fixing seat 22 to limit rotational release of the connection portion 3 and rotation of the engaging end 41 in the clamping slot 21. An inwardly extending cutting notch 43 is provided on each of two sides between the stop tab 42 and the stopper 4 for being cut through, so that the stop tab 42 separates from the stopper 4, thereby removing the limitation on rotation of the connection portion 3.

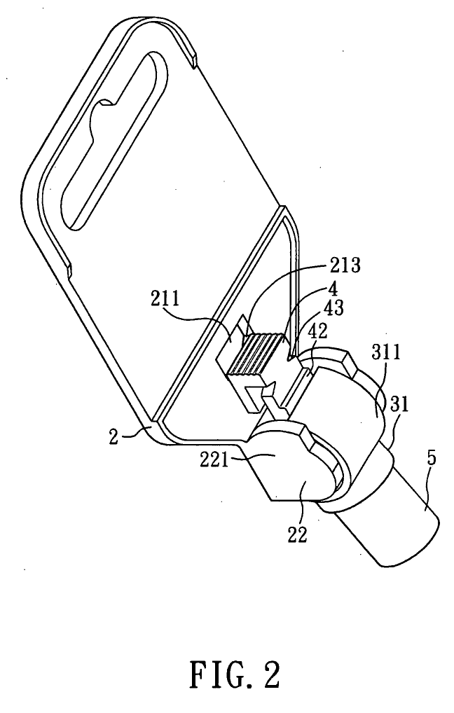

Referring to FIGS. 2 and 3, if the anti-theft structure of the present invention is to be disabled, a user only has to cut through the cutting notches 43 to separate the stop tab 42 from the stopper 4, as shown in FIG. 3. Thus, the stopper 4 is no longer restrained by the stop tab 42 pressing against the fixing seat 22, and is allowed to rotate, so that the engaging end 42 of the stopper 4 can rotate in a same way as the stopper 4. As a result, the engaging end 41 can rotate in the engaging slot 212 without being limited by the arcuate seat 213 in terms of angle and position. At this time, removal of the stopper 4 completes the disenabling of the anti-theft structure. If the anti-theft function is required for a second time, the user only has to replace the old stopper 4 with a new one and push the engaging end 41 of the new stopper 4 into the engaging slot 212 from the receiving slot 211, so that the stop tab 42 presses against the fixing seat 22, thereby limiting rotation of the connection portion 3.

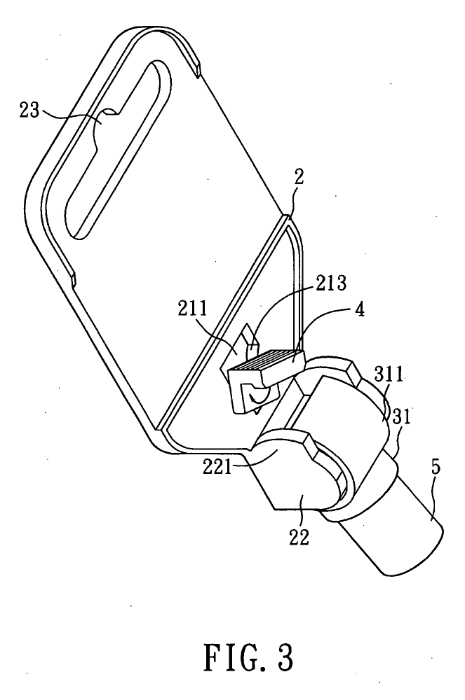

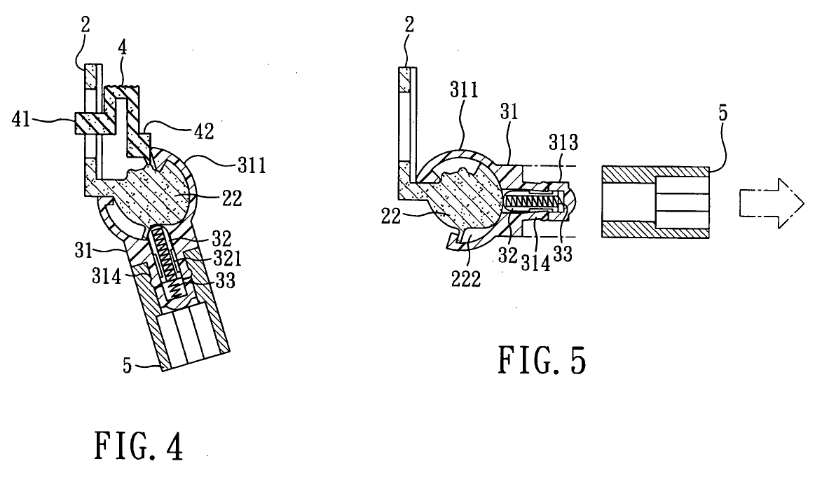

Referring to FIGS. 4 and 5, the fixing seat 22 includes a curved groove 222 for the pusher 32 of the connection portion 3 to press against. When the stop tab 42 is cut off to separate the stopper 4 from the hanger portion 2, the user can rotate the connection portion 3 so that the pusher 32 is disengaged from the curved groove 222, and the pressing of the fixing seat 22 against the pusher 32 makes the pusher 32 move. When the pusher 32 moves further into the hole 312 so that the pressing tab 314 is in positional correspondence to the release portion 321, the pressing tab 314 is no longer prevented from moving inwards and the securing effect is thus canceled, allowing the sleeve 5 to be pulled out.

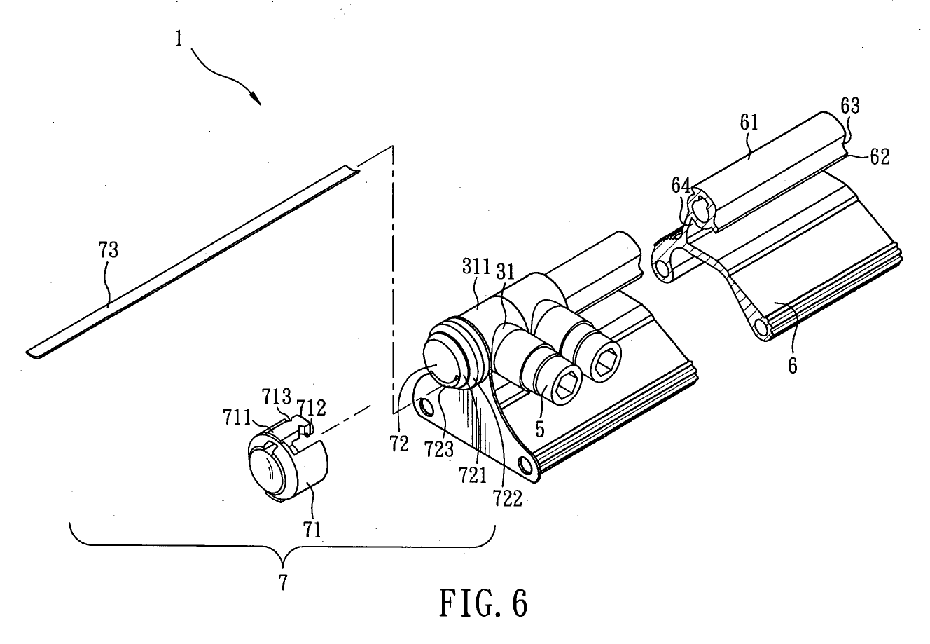

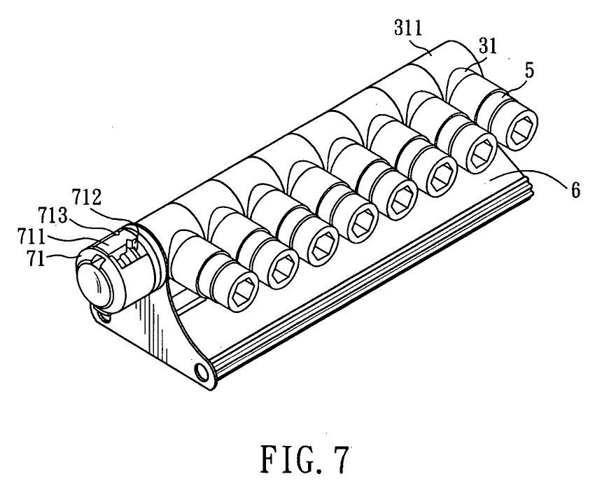

FIGS. 6 and 7 illustrate a second embodiment of the anti-theft display card structure according to the present invention. The second embodiment comprises an extended seat 6 and a securing device 7.

The extended seat 6 has a fixing rod 61 on a top end thereof for a plurality of connection portions 3 to attach rotationally thereto. The fixing rod 61 comprises a retaining rod 62, a curved groove 63 and a retaining groove 64, all of which have a length corresponding to a length of the fixing rod 61. The retaining rod 62 is formed between the curved groove 63 and the retaining groove 64 for limiting a maximum rotation of the connection portion 3. The curved groove 63 is provided for the pusher 32 of the connection portion 3 to press against.

The securing device 7 includes a securing cap 71, a cap seat 72 and an engaging strip 73. The cap seat 72 can be installed at an either end of the fixing rod 61 and has a through hole 723 corresponding to the retaining groove 64 so that the engaging strip 73 can be easily inserted into the retaining groove 64. The cap seat 72 has a curved shape at a head portion thereof and a slope surface 721 around an outer diameter thereof. The engaging strip 73, when put into the retaining groove 64, is pressed by the annular clamp 311 of the rotating portion 31 against the retaining rod 62, thereby limiting rotation of the connection portion 3. The securing cap 71 has one or a plurality of fasteners 711 for fastening the securing cap 71 to the cap seat 72, so that the engaging strip 73 cannot be removed from inside the retaining groove 64.

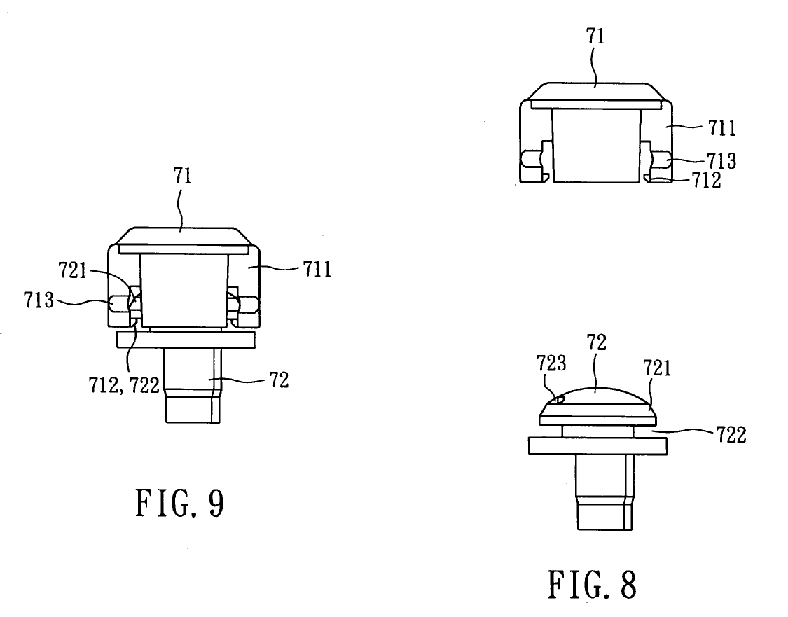

Referring to FIG. 8, the fastener 711 has a lead angle 712 extending inwardly at a bottom end thereof An inwardly extending cutting notch 713 is provided between the fastener 711 and the lead angle 712. Referring to FIG. 9, when the securing cap 71 is pressed onto the cap seat 72, the slope surface 721 of the cap seat 72 allows the lead angle 712 of the fastener 711 to slide easily into and press against a limiting groove 722, so that the securing cap 71 is properly pressed on and engaged with the cap seat 72. The cutting notch 713 can be cut through to separate the engaging strip 711 from the lead angle 712, so that the securing cap 71 is disengaged from the cap seat 72.

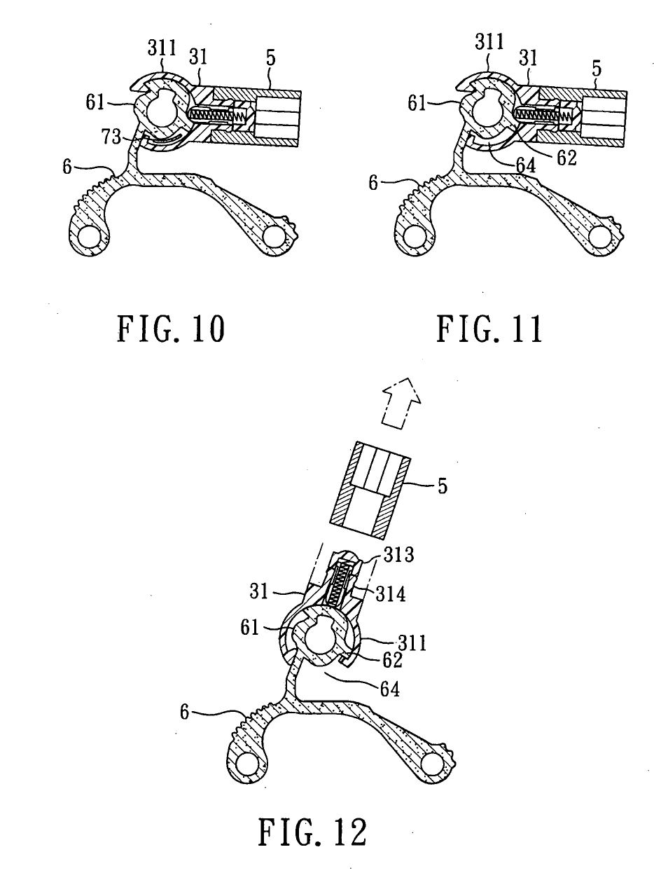

Referring to FIGS. 10 to 12, if the anti-theft structure of this embodiment is to be disenabled, the user only has to cut through the cutting notch 713 and remove the lead angle 712, so that the securing cap 71 is disengaged and separated from the cap seat 72. When the engaging strip 73 is pulled out, the connection portion 3 is no longer secured and is allowed to rotate, as shown in FIGS. 11 and 12. The user can then rotate the connection portion 3 so that the pusher 32 is disengaged from the curved groove 63 and pressed by the fixing rod 61 to move inwards, thereby canceling the securing effect. Please refer to the first embodiment of the present invention for actuation of the connection portion 3, description of which will not be repeated here.

What is claimed is:

1. An anti-theft display card structure, which has a body comprising a hanger portion, a connection portion and a stopper, wherein:
the hanger portion includes a fixing seat for the connection portion to attach thereto and a clamping slot for receiving and securing the stopper, in which the stopper has a stop tab for limiting a rotational release of the connection portion in order to produce an anti-theft effect, and when the stop tab is removed, the connection portion can rotate so as to cancel the anti-theft effect.

2. The anti-theft display card structure as claimed in claim 1, wherein the stopper has an engaging end and the clamping slot includes a receiving slot with a larger slot size, an engaging slot with a smaller slot size, and an arcuate seat formed between the receiving slot and the engaging slot, in which the arcuate seat is an engaging structure with arcuate surfaces and tapering in one direction from the receiving slot towards the engaging slot, so that the engaging end of the stopper can be pushed from the receiving slot into the engaging slot and be secured by the arcuate seat, and the stop tab of the stopper can press against the fixing seat to limit rotation of the engaging end in the clamping slot.

3. The anti-theft display card structure as claimed in claim 1, wherein the connection portion has a rotating portion, a pusher and a resilient element, in which the rotating portion has a hole and a pressing tab; the pusher presses against the fixing seat at an end thereof and is received in the hole together with the resilient element while the pusher can press the pressing tab from inside to limit inward movement of the pressing tab, thereby producing a securing effect; and the pusher has a release portion so that, when the pusher is moved into the hole, the pressing tab can be in positional correspondence to the release portion, thereby removing the limitation on the pressing tab's inward movement and canceling the securing effect.

4. The anti-theft display card structure as claimed in claim 1, wherein the fixing seat has a curved groove, and a stop surface on each of two sides of the fixing seat.

5. The anti-theft display card structure as claimed in claim 1, wherein a cutting notch is provided between the stopper and the stop tab, and the cutting notch can be cut through so that the stopper separates from the stop tab, thereby removing the limitation on rotation of the connection portion.

6. An anti-theft display card structure, which has a body comprising an extended seat, a securing device, and one or a plurality of connection portions, wherein:
the extended seat includes a fixing rod for the connection portion to attach rotationally thereto, in which the fixing rod has a retaining groove; the securing device includes a securing cap and an engaging strip for being inserted into the retaining groove and pressing against the connection portion, thereby limiting a rotational release of the connection portion to produce an anti-theft effect; the securing cap can confine the engaging strip inside the retaining groove; and when the securing cap is removed, the engaging strip is pulled out and the connection portion can rotate so as to canceled the anti-theft effect.

7. The anti-theft display card structure as claimed in claim 6, wherein the securing device includes a cap seat provided at an either end of the fixing rod and having a through hole corresponding to the retaining groove for easy insertion of the engaging strip into the retaining groove, and the securing cap includes one or a plurality of fasteners for fastening the securing cap to the cap seat so that the engaging strip cannot be removed.

8. The anti-theft display card structure as claimed in claim 6, wherein the connection portion has a rotating portion, a pusher and a resilient element, in which the rotating portion has a hole and a pressing tab; the pusher presses against the fixing seat at an end thereof and is received in the hole together with the resilient element while the pusher can press the pressing tab from inside to limit inward movement of the pressing tab, thereby producing a securing effect; and the pusher has a release portion so that, when the pusher is moved into the hole, the pressing tab can be in positional correspondence to the release portion, thereby removing the limitation on the pressing tab's inward movement and canceling the securing effect.

9. The anti-theft display card structure as claimed in claim 7, wherein the cap seat is provided with a slope surface and a limiting groove and the fastener has a cutting notch and a lead angle, in which the slope surface allows the lead angle to slide easily into and press against the limiting groove, so that the securing cap is pressed on and engaged with the cap seat and the cutting notch can be cut through to separate the fastener from the lead angle, thereby disengaging the securing cap from the cap seat.

10. The anti-theft display card structure as claimed in claim 6, wherein the fixing rod has a curved groove and a retaining rod for limiting a maximum rotation of the connection portion.
